(19) United States
(12) Patent Application Publication
(10) Pub. No.: US 2007/0226538 A1
(43) Pub. Date: Sep. 27, 2007

(54) Apparatus and method to manage computer system data in network

(75) Inventors: Min-ho Ban, Anyang-si (KR); Sang-moon Lee, Seoul (KR); Woo-jin Yang, Incheon (KR); Chang-sung Lee, Anyang-si (KR); Doo-sik Park, Suwon-si (KR); Soon-churl Shin, Ansan-si (KR)

Correspondence Address: STEIN, MCEWEN & BUI, LLP, 1400 EYE STREET, NW, SUITE 300, WASHINGTON, DC, 20005, US

(73) Assignee: Samsung Electronics Co., Ltd., Suwon-si (KR)

(21) Appl. No.: 11/703,137

(22) Filed: Feb. 7, 2007

(30) Foreign Application Priority Data
Mar. 9, 2006 (KR) 2006-22339

(51) Int. Cl. G06F 11/00

(52) U.S. Cl. 714/13

(57) ABSTRACT

A data-management apparatus and method, the apparatus including: a display unit to display a user interface that includes management options for a plurality of load-balancing cluster-based devices connected through a network; an input unit to receive a selection value; and a control unit to manage the plurality of load-balancing cluster-based devices according to the inputted selection value.

### CROSS-REFERENCE TO RELATED APPLICATION

This application claims the benefit of Korean Patent Application No. 2006-22339 filed on Mar. 9, 2006 in the Korean Intellectual Property Office, the disclosure of which is incorporated herein by reference.

### BACKGROUND OF THE INVENTION

1. Field of the Invention

Aspects of the present invention relate to managing computer system data in a network. More particularly, aspects of the present invention relate to a method and apparatus that efficiently manages computer system data in a load-balanced cluster environment.

2. Description of the Related Art

As the computer network and the World Wide Web develop, the number of Internet users and web servers is rapidly increasing. However, despite the development of network technology, large numbers of users are causing bottlenecks in web servers.

In order to solve such a problem, the concept of a cluster has been applied to web servers. The cluster refers to a set of computers that are operated like a single computer by connecting multiple computers through a network. Furthermore, the cluster is classified as a scientific-computing cluster and a load-balanced cluster depending on the purpose of use.

The scientific-computing cluster is used to carry out large-scale operations that are difficult or time-consuming for a general-purpose computer. For example, the scientific-computer cluster is used in fields such as a weather forecasting, nuclear explosion simulation, hydromechanics, animation, and film special effects. In comparison, the load-balancing cluster is mainly used as a web server. The load-balancing cluster provides a method that can solve the overload of a web server by distributing the load to other nodes. However, the operating systems of some cluster nodes often must be re-installed. For example, in the case where there is an error in a certain cluster node, or the use of the cluster node must be changed, the operating system must be re-installed. Here, a computer or network manager must move to the cluster node, stop an operation thereof, and re-install the operating system. However, in the case of a large-scale cluster, it is not easy for the manager or user to find the malfunctioning cluster node, which lowers the efficiency of system management.

Further, because a cluster is not a general-purpose system, after a system is configured for a certain application field, all related information (such as operating system and setting data) must be backed up. Accordingly, if system-related information is backed up and an error occurs in the system afterwards, the system can be recovered using backup data, though the system cannot be recovered to the current state, which is a problem. Further, according to the conventional art, since all the data in a disk for each cluster node should be copied in order to back up system-related information, there is a problem in that time is wasted.

Accordingly, there is a need for an apparatus and method to effectively manage computer data in a cluster.

### SUMMARY OF THE INVENTION

Aspects of the present invention provide an apparatus and method to efficiently manage data in a load-balancing cluster environment.

According to an aspect of the present invention, there is provided a data-management apparatus including a display unit to display a user interface that includes management options for a plurality of load-balancing cluster-based devices connected through a network; an input unit to receive a selection value; and a control unit to manage the plurality of load-balancing cluster-based devices according to the inputted selection value.

According to another aspect of the present invention, there is provided a data-management apparatus including a receiving unit to receive a selection value of a user from a server in a load-balancing cluster-based network; a control unit to generate an image file according to the received selection value; and a transmission unit to transmit the image file to the server.

According to yet another aspect of the present invention, there is provided a method of managing data, the method including displaying a user interface that includes management options for a plurality of load-balancing cluster-based devices connected through a network; receiving a selection value; and managing the plurality of load-balancing cluster-based devices according to the inputted selection value.

According to still another aspect of the present invention, there is provided a method of managing data, the method including receiving a selection value from a server in a load-balancing cluster-based network; generating an image file according to the received selection value; and transmitting the image file to the server.

Additional aspects and/or advantages of the invention will be set forth in part in the description which follows and, in part, will be obvious from the description, or may be learned by practice of the invention.

### BRIEF DESCRIPTION OF THE DRAWINGS

These and/or other aspects and advantages of the invention will become apparent and more readily appreciated from the following description of the embodiments, taken in conjunction with the accompanying drawings of which:

FIG. 1 illustrates a structure of a system to manage data according to an embodiment of the present invention.

FIG. 2 is a block diagram illustrating a structure of a data-management apparatus according to an embodiment of the present invention.

FIGS. 3A and 3B illustrate a user interface that is provided in a data-management apparatus according to an embodiment of the present invention.

FIG. 4 is a block diagram illustrating a structure of a node according to an embodiment of the present invention.

FIG. 5 illustrates a backup process among methods of managing data according to an embodiment of the present invention.

FIG. 6 illustrates a recovery process among methods of managing data according to an embodiment of the present invention.

### DETAILED DESCRIPTION OF THE EMBODIMENTS

Reference will now be made in detail to the present embodiments of the present invention, examples of which are illustrated in the accompanying drawings, wherein like reference numerals refer to the like elements throughout. The embodiments are described below in order to explain the present invention by referring to the figures.

Aspects of the present invention are described hereinafter with reference to flowchart illustrations of user interfaces, methods, and computer program products according to embodiments of the invention. It should be understood that each block of the flowchart illustrations and combinations of blocks in the flowchart illustrations can be implemented by computer program instructions. These computer program instructions can be provided to a processor of a general purpose computer, special purpose computer, or other programmable data processing apparatus to produce a machine, such that the instructions, which execute via the processor of the computer or other programmable data processing apparatus, create methods to implement the functions specified in the flowchart block or blocks.

These computer program instructions may also be stored in a computer-usable or computer-readable memory that can direct a computer or other programmable data processing apparatus to function in a particular manner, such that the instructions stored in the computer-usable or computer-readable memory produce an article of manufacture including instruction methods that implement the function specified in the flowchart block or blocks.

The computer program instructions may also be loaded into a computer or other programmable data processing apparatus to cause a series of operations to be performed in the computer or other programmable apparatus to produce a computer-implemented process such that the instructions that execute on the computer or other programmable apparatus provide operations to implement the functions specified in the flowchart block or blocks.

And each block of the flowchart illustrations may represent a module, segment, or portion of code, which includes one or more executable instructions to implement the specified logical function(s). It should also be noted that in some alternative implementations, the functions noted in the blocks may occur out of order. For example, two blocks shown in succession may in fact be executed substantially concurrently or the blocks may sometimes be executed in reverse order depending upon the functionality involved.

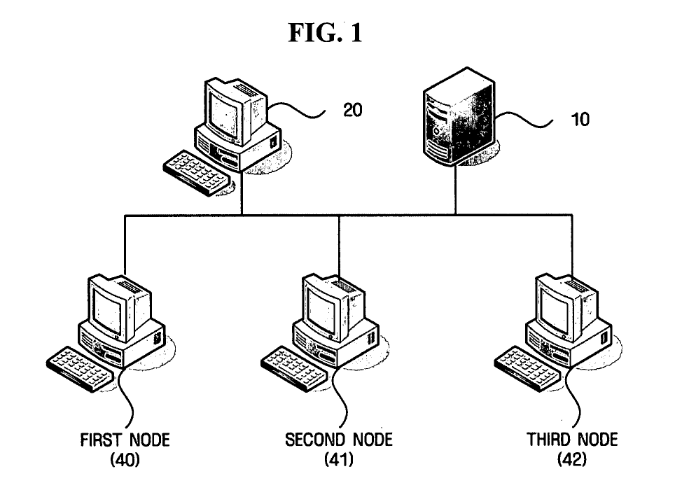

FIG. 1 illustrates a structure of a system to manage data according to an embodiment of the present invention. A remote data-management system according to an embodiment is a load-balancing cluster, and includes a data-management apparatus 20, multiple nodes 40, 41, and 42, a backup storage device 10.

The load-balancing cluster can be implemented by the Direct Routing (DR) method or the Network Address Translation (NAT) method. The DR method is a method where a load-balancing server distributes a request from an outside client to another node, and the node that the request is allocated to directly responds to the outside client. The NAT method is similar to the DR method, except that the node that is allocated the request from the outside client sends a response to the outside client through the load-balancing server. It is understood that the load-balancing cluster can use a combination of the NAT method and the DR method.

Furthermore, according to an aspect, the data-management apparatus 20 and the nodes 40, 41, and 42 may provide a pre-boot execution environment (PXE). Here, PXE is an industrial standard of a client and server interface that allows a manager or user in a remote area to boot a client connected in a network. The PXE code is included in a boot disk that makes communication between the client and the server possible and is transmitted to the client through the network.

According to an aspect, the data-management apparatus 20 provides a user interface for the manager or user to input at least one of a selection value for specific nodes 40, 41 and 42 in the network, a selection value for a specific data-storage area from among data-storage areas of the selected nodes 40, 41 and 42, and a selection value for a control command. Here, some examples of the control command are backup, installation, and recovery.

Further, the data-management apparatus 20 receives an image file of each node 40, 41 and 42 from the nodes 40, 41 and 42 on the network. In the case where an error occurs in a certain node, the data-management apparatus 20 recovers the node using the image file of the node from among the received image files. Moreover, the data-management apparatus 20 may periodically store image files, which have already been stored, in the backup storage device 10.

The nodes 40, 41 and 42 are booted through a network by the data-management apparatus 20. The booted nodes 40, 41 and 42 provide information about their own data-storage area to the data-management apparatus 20, and recover the data-storage area based on the image file received from the data-management apparatus 20.

The backup storage device 10 stores various setting information of the data-management apparatus 20. The setting information is periodically updated by the data-management apparatus 20. Further, the backup storage device 10 stores an image file provided from the data-management apparatus 20. As such, in the case where an error occurs in the data-management apparatus 20, the backup storage device 10 provides the image file necessary to recover the data-management apparatus 20.

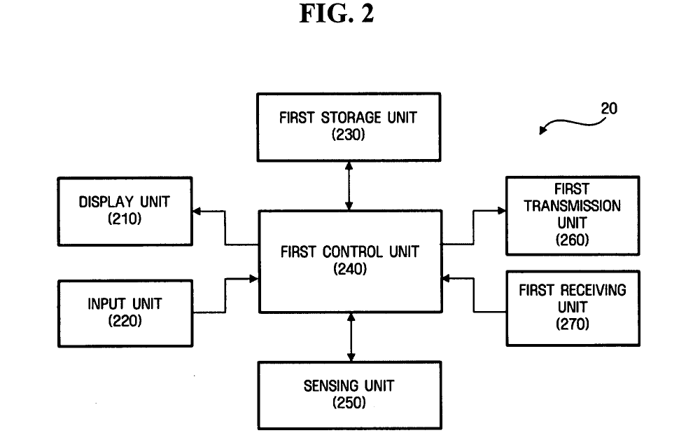

The data-management apparatus 20 according to an embodiment will now be described with reference to FIG. 2. Here, FIG. 2 is a block diagram illustrating the structure of a data-management apparatus 20 according to an embodiment of the present invention.

The data-management apparatus illustrated in FIG. 2 includes a display unit 210, an input unit 220, a first transmission unit 260, a receiving unit 270, a control unit 240, and a sensing unit 250.

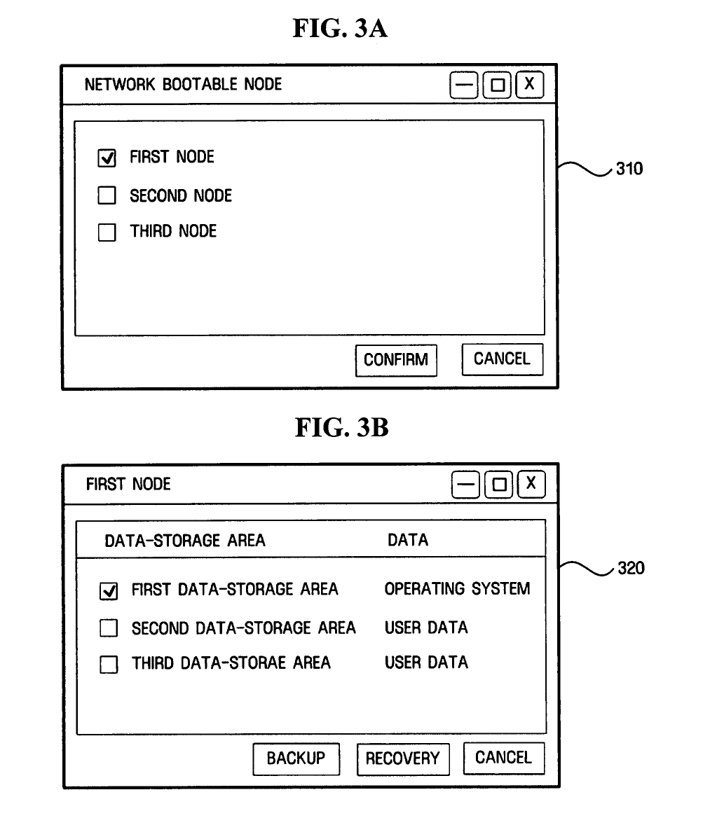

The display unit 210 displays the result of a command execution in a visible form. For example, the display unit 210 displays a user interface allowing the manager or user to select at least one of a specific node on a network, a specific data-storage area from among data-storage areas of a certain node, and a control command. The user interface will now be described with reference to FIGS. 3A and 3B.

FIGS. 3A and 3B illustrate user interfaces 310 and 320 that are provided in a data-management apparatus 20 according to an embodiment of the present invention. The manager or user can select a node to be remotely managed in the user interface 310 as illustrated in FIG. 3A.

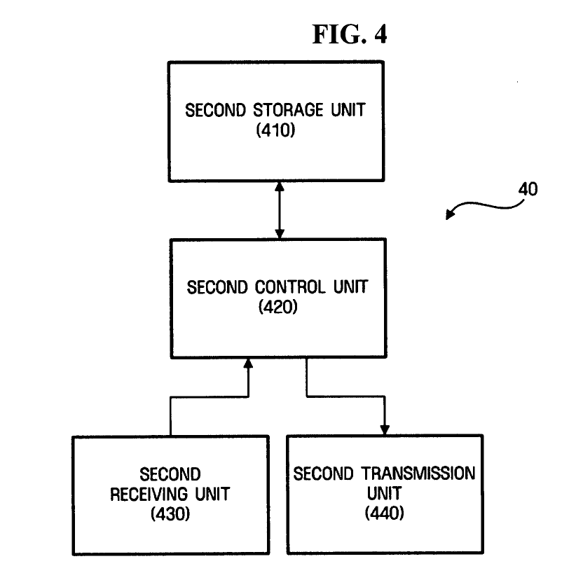

If a specific node 40 is selected in the user interface 310 as illustrated in FIG. 3A, the node selected by the manager or user is booted through the network, and then provides information about its own data-storage area (such as partition information and information about the type of data stored in each partition) to the data-management apparatus 20. For example, in the case where the first node 40 is selected, as illustrated in FIG. 3A, the first node 40 is booted through a network, and then provides information, such as how many data-storage areas the second storage unit (refer to reference numeral 410 of FIG. 4) has been partitioned into and the types of data stored in each data-storage area, to the data-management apparatus 20.

Further, if information about the data-storage area is provided, the data-management apparatus 20 displays the information through the user interface 310. FIG. 3B illustrates the user interface 320 that includes information received from the node booted through the network. FIG. 3B shows that the data-storage area of the node 40 is partitioned into a first area, a second area and a third area, such that the operating system is stored in the first area, and user data is stored in the second area and the third area. Further, the user interface 320 can include a check box to select each data-storage area, and a control command icon that can be executed on the selected data-storage area. However, it is understood that other methods may be used to select the data-storage area, such as a highlighting or icon demarcating the selection.

Referring to FIG. 2, a network manager or user inputs a selection value to the input unit 220. For example, the input unit 220 receives a selection value for a specific node 40, 41, and 42, a selection value for a specific data-storage area among multiple data-storage areas of a certain node, and/or a selection value for a control command. The selection value inputted through the input unit 220 is provided to the first control unit 240.

The first transmission unit 260 transmits data to nodes 40, 41 and 42 on the network, and the backup storage device 10. For example, the first transmission unit 260 transmits a selection value provided through the input unit 220 (such as a selection value for the data-storage area and a selection value for the control command) to the node. Further, the first transmission unit 260 transmits the image file necessary to recover a certain data-storage area among data-storage areas of the node 40, 41, and 42 selected by the manager or the user, to the node. Further, the first transmission unit 260 transmits the image file stored in the data-management apparatus 20 to the backup storage device 10.

The first control unit 240 connects and manages components within the data-management apparatus 20. For example, the first control unit 240 controls components within the data-management apparatus 20 according to input values provided through the input unit 220. Specifically, after a specific node 40, 41, and 42 is selected, in the case where the value to boot the selected node through the network is inputted, the first control unit 240 provides network information about the selected node 40, 41, and 42 (such as an Internet Protocol (IP) address to access the data-management apparatus 20, a subnet mask within a cluster, a boot-directory path of the data-management apparatus 20 having a boot file, and the name of a kernel image) through the transmission network 260 to the node 40, 41, and 42.

Here, the data-management apparatus 20 can use the Dynamic Host Configuration Protocol (DHCP) so that the selected node 40, 41, and 42 generates an IP address to access the data-management apparatus 20. DHCP refers to a protocol for managing and allocating IP addresses on a network. In the Transmission Control Protocol/Internet Protocol (TCP/IP), each computer can connect to the Internet only when it has a unique IP address. In order for computer users in a network to connect to the Internet, an IP address is allocated to each computer. In the case where the DHCP is not used, an IP address should be manually inputted for each computer, and if computers are moved to a place which belongs to another part of the network, new IP addresses should be inputted. A network manager may manage and allocate IP addresses, and computers automatically send new IP addresses when they are connected to a different place of the network through the DHCP. The DHCP uses the concept of rent to validate given IP addresses for specified hours. The rental hours can vary depending on how long the user needs an Internet connection in a certain place. Further, in the case where there are more computers than available IP addresses, the network can be dynamically reconstituted by making rental hours of the IP addresses short.

Likewise, after transmitting the network information, in the case where a Trivial File Transfer Protocol (TFTP) request is received, the first control unit 240 provides a file necessary for booting the node 40, 41, and 42, and then grants the kernel-control right to the node 40, 41, and 42. As such, the node 40, 41, and 42 examines the device, and initializes peripheral devices.

Then, in the case where a request to a file system of the data-management apparatus 20 is received from the node 40, 41, and 42, the first control unit 240 provides the position of the root directory of the node 40, 41, and 42 to be mounted and the host name of the node 40, 41, and 42 using an IP address, a subnet mask, and Network File System (NFS), by which the node 40, 41, and 42, which received the information, can establish the network.

Then, if the root-file system of the data-management apparatus 20 is mounted, the first control unit 240 provides the file system necessary for booting the node 40, 41, and 42 through the NFS to the node 40, 41, and 42.

The first receiving unit 270 receives data provided from the booted node 40, 41, and 42 through the network, such as information about the data-storage area and information about the types of data stored in each data-storage area. Further, when an error occurs in the data-management apparatus 20, the first receiving unit 270 receives the image file necessary to recover the data-management apparatus 20 from the backup storage device 10.

The first storage unit 230 stores an image file to recover the error-occurred node 40, 41, and 42. This first storage 230 can be implemented as at least one among a nonvolatile memory element such as a cache, Read Only Memory (ROM), Programmable ROM (PROM), Erasable PROM (EPROM), Electrically Erasable PROM (EEPROM), and flash memory, a volatile memory element such as Random Access Memory (RAM), and a storage media such as a Hard Disk Drive (HDD), but not limited thereto.

The sensing unit 250 periodically checks the state of the data-management apparatus 20, and in the case where the setting information is changed, the changed information is stored in the backup storage unit 10. Further, the sensing unit 250 periodically checks an error occurrence of the data-management apparatus 20, and stores an image file stored in the first storage unit 230 in the backup storage apparatus 10. As such, in the case where an error occurs in the data-management apparatus 20, the sensing unit 250 receives an image file necessary to recover the data-management apparatus 20 from the backup storage apparatus 10, and corrects the error.

Next, a node 40 is described with reference to FIG. 4. Here, FIG. 4 is a block diagram illustrating a structure of a node 40 according to an embodiment of the present invention. The node 40 illustrated in FIG. 4 includes a second storage unit 410, a second receiving unit 430, a second transmission unit 440, and a second control unit 420.

The second storage unit 410 stores data on the operating system necessary for booting, and various user data. The second storage unit 410 can be implemented as a storage media, such as an HDD. The HDD can be partitioned as a plurality of data-storage areas, and operating system and user data can be stored in each partitioned data-storage area depending on the use.

The second receiving unit 430 receives network information, files necessary to boot the node 40 through the network, and the selection value inputted by the manager or the user.

The second control unit 420 connects and manages components within the node 40. For example, in the case where the node 40 is booted through the network, the second control unit 420 mounts the first storage unit 230 of the data-management apparatus 20. Here, the second control unit 420 can mount the first storage unit 230 of the data-management apparatus through the NFS.

The NFS refers to a client and server-type program by which a user can retrieve, store, and correct files in a remote computer. In the case where the NFS is used in a cluster, accounts can be easily managed, and data, which requires much disk space, can be stored and managed in one node 40. Because the NFS is based on a client and server model, the server provides a directory for services, and the client mounts a directory provided in the server for use. The directory provided from the server can be mounted at any position of the node 40, all nodes 40, 41, and 42, which are provided NFS services, can access files within the directory of the server, and thus files can be easily managed.

Likewise, after mounting the first storage unit 230 of the data-management apparatus 20, the second control unit 420 provides information about the second storage unit 410 (such as information about data-storage areas and information about the types of data stored in each data-storage area) to the data-management apparatus 20.

Then, in the case where the selection value for the data-storage area of the second storage unit 410 and the selection value for the control command are received from the data-management apparatus 20, the second control unit 420 generates an image file of the data-storage area corresponding to the selection value.

The second transmission unit 440 transmits the image file generated by the second control unit 420 to the data-management apparatus 20.

The term module, as used herein, refers to, but is not limited to, a software or hardware component, such as a Field Programmable Gate Array (FPGA) or an Application Specific Integrated Circuit (ASIC), which performs certain tasks. A module may advantageously be configured to reside on the addressable storage medium and configured to execute on one or more processors. Thus, a module may include, by way of example, components, such as software components, object-oriented software components, class components and task components, processes, functions, attributes, procedures, subroutines, segments of program code, drivers, firmware, microcode, circuitry, data, databases, data structures, tables, arrays, and variables. The functionality provided for in the components and modules may be combined into fewer components and modules or further separated into additional components and modules.

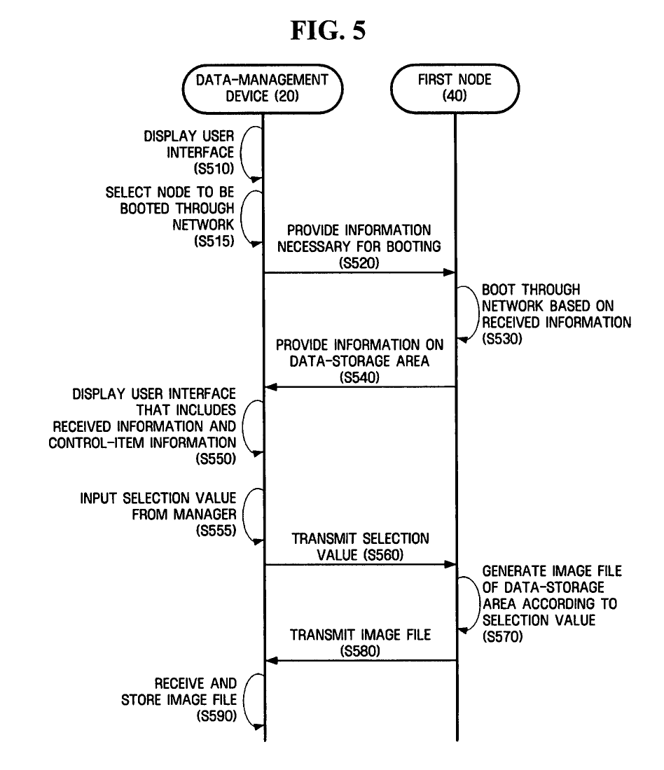

FIG. 5 illustrates a backup process among methods of managing data according to an embodiment of the present invention. First, the data-management apparatus 20 displays a user interface 310 that includes information about nodes 40, 41, and 42 in the network through the display unit 210, as illustrated in FIG. 3A (operation S510). The manager can select nodes 40, 41, and 42 to be booted through the network in the user interface 310 as illustrated in FIG. 3A (operation S515).

If the first node 40 is selected by a manager or user, the data-management apparatus 20 boots the first node 40 through the network. For example, as illustrated in FIG. 3A, in the case where the first node 40 is selected, the data-management apparatus 20 provides to the first node 40 network information such as an IP address to access the data-management apparatus 20, a subnet mask within the cluster, a boot directory path of the data-management apparatus 20 having the boot file and the name of the kernel image (operation S520).

Then, the first node 40 sets the network using the network information received from the data-management apparatus 20. If the network is set, the first node 40 transmits a TFTP request to the data-management apparatus 20 in order to download files necessary for booting.

Further, the data-management apparatus 20, which received the TFTP request from the first node 40, transmits the file necessary for booting to the first node 40, and grants the kernel-control right to the first node 40.

The first node 40, which received the kernel-control right, examines the device, initializes peripheral devices, and then requests the file system of the data-management apparatus 20 from the data-management apparatus 20.

The data-management apparatus 20 provides to the first node 40 an IP address, a subnet mask, a root-directory position of the node to be mounted using the NFS, a gateway address and a host name of the first node 40.

If the network is established based on information provided from the data-management apparatus 20, the first node 40 mounts the root-file system of the data-management apparatus 20. After the root-file system of the data-management apparatus 20 is mounted, the first node 40 is provided a necessary file system from the data-management apparatus 20 through the NFS, and thus boots the system (operation S530).

Likewise, the first node 40, which is booted through the network, provides information on its own data-storage area to the data-management apparatus 20 (operation S540). In other words, in the case where the second storage unit 410 of the first node 40 is partitioned as multiple data-storage areas of the first node 40, information on each partitioned data-storage area and information on data stored in each data-storage area are provided to the data-management apparatus 20.

Further, if information on the data-storage area is received from the first node 40, the data-management apparatus 20 displays, through the display unit 210, a user interface 320 that includes information on the data-storage areas received from the first node 40 and an icon that can select each data-storage area (operation S550).

If the user interface 310 is displayed as illustrated in FIG. 3B, the manager can select a backup command and a data-storage area in which a backup command will be performed (operation S555). Then, the data-management apparatus 20 transmits the selection value to the first node 40 (operation S560).

Further, the first node 40, which received the selection value from the data-management apparatus 20, performs a backup according to a result of analyzing the received selection value. For example, as a result of the analysis on the selection value received from the data-management apparatus 20, in the case where the selection value instructing a backing up of the data of the first data-storage area is received, the first node 40 generates an image file of data of the first data-storage area (operation S570). If the image file of the data of the first data-storage area is generated, the first node 40 transmits the image file to the data-management apparatus 20 (operation S580).

The image file transmitted from the first node 20 to the data-management apparatus 20 is received and stored in the first storage unit 230 (operation S590).

Further, the data-management apparatus 20 periodically checks for occurrences of errors in the data-management apparatus 20, and stores the image file stored in the first storage unit 230 in a backup storage device 10. If an error occurs in the data-management apparatus 20, a necessary image file is provided to the data-management apparatus 20, and the error is corrected.

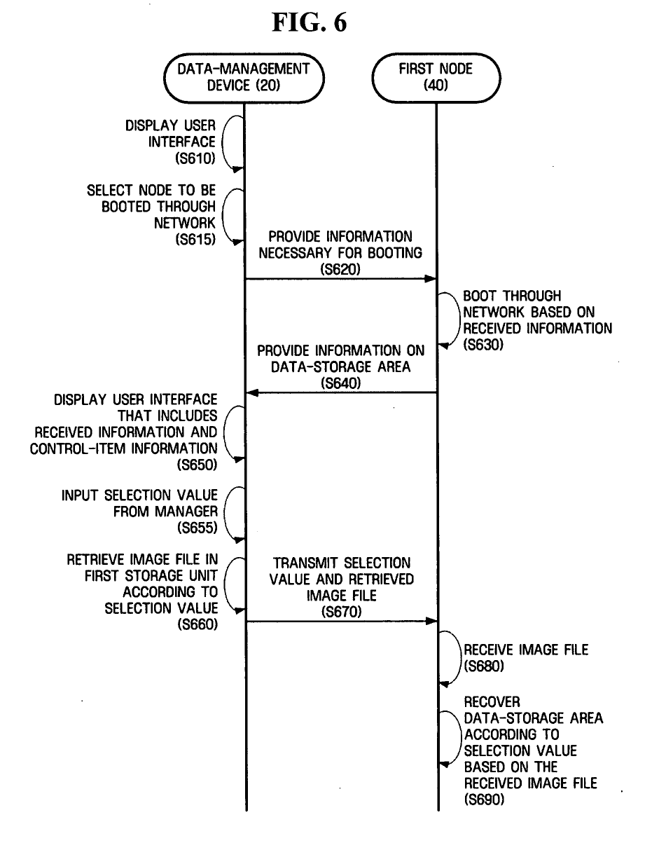

FIG. 6 illustrates a method of managing data according to an embodiment of the present invention, and specifically illustrates a process of recovering data according to a selection value of a manager or user. The process by which the node 40 is selected by the manager, e.g., the first node 40, and is booted through the network, is omitted here because the process is the same as the process illustrated in FIG. 5.

In the case where a data-storage area to perform recovery is selected from among data-storage areas of the first node 40, and the recovery command is selected through the user interface 320 as illustrated in FIG. 3B, the data-management apparatus 20 retrieves an image file to recover the data-storage area (operation S660). For example, as illustrated in FIG. 3B, in the case where the first data-storage area and the recovery command are selected by the manager or the user, the data-management apparatus 20 retrieves an image file necessary to recover the first data-storage area of the first node 40 in the first storage unit 230. Then, the data-management apparatus 20 provides the retrieved image file to the first node (operation S670).

Further, if the image file necessary for recovery is received from the data-management apparatus 20, the first node 40 recovers the first data-storage area using the received image file (operation S690).

Aspects of the present invention have the following advantages. First, data can be selectively backed up and recovered. Second, time necessary for data backup and recovery can be reduced. Third, data can be backed up and recovered while a node 40, 41, and 42 is operating.

Although a few embodiments of the present invention have been shown and described, it would be appreciated by those skilled in the art that changes may be made in this embodiment without departing from the principles and spirit of the invention, the scope of which is defined in the claims and their equivalents.

What is claimed is:

1. A data-management apparatus comprising:
a user interface comprising management options for one or more load-balancing cluster-based devices connected through a network;
a display unit to display the user interface;
an input unit to receive a management selection value corresponding to one or more of the management options; and
a control unit to manage the one or more load-balancing cluster-based devices according to the inputted management selection value.

2. The apparatus as claimed in claim 1, wherein the management options comprise at least one of:
a backup operation to backup one or more of the load-balancing cluster-based devices;
a recovery operation to recover one or more of the load-balancing cluster-based device; and/or
an installation operation to perform an installation on one or more of the load-balancing cluster-based devices.

3. The apparatus as claimed in claim 1, wherein:
the user interface further comprises data-storage area options corresponding to data-storage areas of the one or more load-balancing cluster-based devices;
the input unit receives a data-storage area selection value to select one or more of the data-storage area options; and
the control unit manages one or more selected data-storage areas, corresponding to the data-storage area selection value, according to the inputted management selection value.

4. The apparatus as claimed in claim 3, wherein the user interface further comprises data type information of the data-storage area options.

5. The apparatus as claimed in claim 1, wherein:
the user interface further comprises device options corresponding to the one or more load-balancing cluster-based devices;
the input unit receives a device selection value to select one or more of the device options; and
the control unit manages one or more selected load-balancing cluster-based devices, corresponding to the device selection value, according to the inputted management selection value.

6. The apparatus as claimed in claim 5, wherein:
the user interface further comprises data-storage area options corresponding to data-storage areas of the one or more selected load-balancing cluster-based devices corresponding to the device selection value;
the input unit receives a data-storage area selection value to select one or more of the data-storage area options; and
the control unit manages one or more selected data-storage areas, corresponding to the data-storage area selection value, according to the inputted management selection value.

7. The apparatus as claimed in claim 5, wherein the one or more selected load-balancing cluster-based devices are remotely booted through the network.

8. The apparatus as claimed in claim 5, further comprising:
a transmission unit to transmit the management selection value to the one or more selected load-balancing cluster-based devices.

9. The apparatus as claimed in claim 8, further comprising:
a receiving unit to receive an image file of a data-storage area of the one or more selected load-balancing cluster-based devices when the management selection value corresponds to a backup operation.

10. The apparatus as claimed in claim 9, further comprising:
a storage unit to store the received image file.

11. The apparatus as claimed in claim 10, wherein the transmitting unit transmits the image file to a backup storage device.

12. The apparatus as claimed in claim 9, wherein the transmitting unit transmits the image file to a backup storage device.

13. The apparatus as claimed in claim 9, wherein the transmission unit transmits the image file of the data-storage area of the one or more selected load-balancing cluster-based devices when the management selection value corresponds to a recovery operation.

14. The apparatus as claimed in claim 11, wherein:
the receiving unit receives the image file of the data-storage area of the one or more selected load-balancing cluster-based devices from the backup storage device.

15. The apparatus as claimed in claim 8, further comprising:
a sensing unit to periodically sense an error occurrence in the apparatus, wherein:
the transmitting unit transmits an image file of the apparatus to a backup storage device and if the sensing unit senses an error, the receiving unit receives the image file and the sensing unit corrects the error based on the image file.

16. The apparatus as claimed in claim 1, wherein the one or more load-balancing cluster-based devices are remotely booted through the network.

17. A data-management node apparatus comprising:
a receiving unit to receive a management selection value corresponding to one or more management options from a server in a load-balancing cluster-based network; and
a control unit to perform the one or more management options according to the received management selection value.

18. The apparatus as claimed in claim 17, wherein the one or more management options comprise at least one of:
a backup operation to backup the apparatus;
a recovery operation to recover the apparatus; and/or
an installation operation to install an application, operating system, and/or file on the apparatus.

19. The apparatus as claimed in claim 17, further comprising:
a transmitting unit to transmit, to the server, an image file of the apparatus created by the control unit when the received management selection value corresponds to a backup operation.

20. The apparatus as claimed in claim 19, wherein:
the receiving unit receives the image file from the server when the management selection value corresponds to a recovery operation; and
the control unit recovers the image file.

21. A method of managing data, the method comprising:
displaying a user interface comprising management options for one or more load-balancing cluster-based devices connected through a network;
receiving a management selection value corresponding to one or more of the management options; and
managing the one or more load-balancing cluster-based devices according to the received management selection value.

22. The method as claimed in claim 21, wherein the managing of the one or more load-balancing cluster-based devices comprises at least one of:
performing a backup of the one or more load-balancing cluster-based devices;
performing a recovery of the one or more load-balancing cluster-based devices; and/or
performing an installation on the one or more load-balancing cluster-based devices.

23. The method as claimed in claim 21, wherein the user interface further comprises data-storage area options corresponding to data-storage areas of the one or more load-balancing cluster-based devices.

24. The method as claimed in claim 23, further comprising:
receiving a data-storage area selection value to select one or more of the data-storage area options, wherein
the managing of the one or more load-balancing cluster-based devices comprises managing one or more selected data-storage areas corresponding to the data-storage area selection value.

25. The method as claimed in claim 23, wherein the user interface further comprises data type information of the data-storage area options.

26. The method as claimed in claim 21, further comprising:
receiving a device selection value to select one or more of the load-balancing cluster-based devices, wherein
the managing of the one or more load-balancing cluster-based devices comprises managing the one or more selected load-balancing cluster-based devices corresponding to the device selection value.

27. The method as claimed in claim 26, further comprising:
receiving a data-storage area selection value to select one or more data-storage areas of the one or more selected load-balancing cluster-based devices, wherein
the managing of the one or more selected load-balancing cluster-based devices comprises managing the one or more selected data-storage areas corresponding to the data-storage area selection value.

28. The method as claimed in claim 26, wherein the managing of the one or more selected load-balancing cluster based devices comprises booting the one or more selected load-balancing cluster-based devices remotely through the network.

29. The method as claimed in claim 26, wherein the managing of the one or more selected load-balancing cluster-based devices comprises:
transmitting the management selection value to the one or more selected load-balancing cluster-based devices.

30. The method as claimed in claim 29, wherein the managing of the one or more selected load-balancing cluster-based devices further comprises:
receiving an image file of a data-storage area of the one or more selected load-balancing cluster-based devices when the management selection value corresponds to a backup operation.

31. The method as claimed in claim 30, wherein the managing of the one or more selected load-balancing cluster-based devices further comprises:
storing the received image file.

32. The method as claimed in claim 31, wherein the managing of the one or more selected load-balancing cluster-based devices further comprises:
transmitting the image file to a backup storage device.

33. The method as claimed in claim 30, wherein the managing of the one or more selected load-balancing cluster-based devices further comprises:
transmitting the image file to a backup storage device.

34. The method as claimed in claim 29, wherein the managing of the one or more selected load-balancing cluster-based devices further comprises:
transmitting an image file of a data-storage area of the one or more selected load-balancing cluster-based devices when the management selection value corresponds to a recovery operation.

35. The method as claimed in claim 29, wherein the managing of the one or more selected load-balancing cluster-based devices further comprises:
receiving an image file of a data-storage area of the one or more selected load-balancing cluster-based devices from a backup storage device.

36. The method as claimed in claim 21, further comprising:
storing an image file in a backup-storage device;
periodically sensing an error occurrence; and
correcting an error if the error occurrence is sensed based on the image file.

37. The method as claimed in claim 21, wherein the one or more load-balancing cluster-based devices are remotely booted through the network.

38. A method of managing data, the method comprising:
receiving a management selection value corresponding to one or more management options from a server in a load-balancing cluster-based network; and
performing the one or more management options according to the received management selection value.

39. The method as claimed in claim 38, wherein the performing of the one or more management options comprises at least one of:
performing a backup operation;
performing a recovery operation; and/or
performing an installation operation.

40. The method as claimed in claim 38, further comprising:
transmitting, to the server, an image file when the received management selection value corresponds to a backup operation.

41. The method as claimed in claim 38, further comprising:
receiving an image file from the server when the received management selection value corresponds to a recovery operation; and
recovering the image file.

42. A method of managing data, the method comprising:
receiving a management selection value corresponding to one or more management options for one or more load-balancing cluster-based devices connected through a network; and
managing the one or more load-balancing cluster-based devices according to the received management selection value.

43. The method as claimed in claim 42, further comprising:
displaying a user interface comprising the one or more management options;

44. The method as claimed in claim 42, further comprising:
receiving a device selection value to select one or more of the load-balancing cluster-based devices, wherein
the managing of the one or more load-balancing cluster-based devices comprises managing the one or more selected load-balancing cluster-based devices corresponding to the device selection value.

45. The method as claimed in claim 44, further comprising:
receiving a data-storage area selection value to select one or more data-storage areas of the one or more selected load-balancing cluster-based devices, wherein
the managing of the one or more selected load-balancing cluster-based devices comprises managing the one or more selected data-storage areas corresponding to the data-storage area selection value.

46. The method as claimed in claim 44, wherein the managing of the one or more selected load-balancing cluster-based devices comprises:
transmitting the management selection value to the one or more selected load-balancing cluster-based devices.

47. The method as claimed in claim 46, wherein the managing of the one or more selected load-balancing cluster-based devices further comprises:
receiving an image file of a data-storage area of the one or more selected load-balancing cluster-based devices when the management selection value corresponds to a backup operation; and
storing the received image file.

48. The method as claimed in claim 47, wherein the managing of the one or more selected load-balancing cluster-based devices further comprises:
transmitting the image file to a backup storage device.

49. The method as claimed in claim 46, wherein the managing of the one or more selected load-balancing cluster-based devices further comprises:
transmitting an image file of a data-storage area of the one or more selected load-balancing cluster-based devices when the management selection value corresponds to a recovery operation.

50. The method as claimed in claim 42, further comprising:
storing an image file in a backup-storage device;
periodically sensing an error occurrence; and
correcting an error if the error occurrence is sensed based on the image file.

51. The method as claimed in claim 42, wherein the managing of the one or more load-balancing cluster-based devices requires no user action at the one or more load-balancing cluster-based devices.
